(19) United States
(12) Patent Application Publication
(10) Pub. No.: US 2026/0227055 A1
(43) Pub. Date: Aug. 6, 2026

(54) DUAL MEMBER FASTENING ELEMENT

(71) Applicant: SIGNIFY HOLDING B.V., EINDHOVEN (NL)

(72) Inventors: CARLOS MISSAEL MEDINA ROBLES, SAN NICOLAS DE LOS GARZA (MX); ALVARO PEQUEÑO MONDRAGON, GARCÍA (MX); JOSE ALDO RAMIREZ SALAIS, MONTERREY (MX); EDUARDO NAVA PALOMARES, ESCOBE (MX)

(21) Appl. No.: 19/157,401

(22) PCT Filed: Feb. 15, 2024
(86) PCT No.: PCT/EP2024/053854

§ 371 Date: Aug. 18, 2025

Related U.S. Application Data
(60) Provisional application No. 63/446,927, filed on Feb. 20, 2023.

(30) Foreign Application Priority Data
Apr. 6, 2023 (EP) 23166944.1

(51) Int. Cl. F21V 19/00; F16B 21/08; F21Y 115/10

(52) U.S. Cl. CPC F21V 19/004; F16B 21/086; F21V 17/164; F21V 19/0035; F21Y 2115/10

(57) ABSTRACT

A dual member fastening element for engaging a planar object and optic to a carrier, including a first portion having one or more first resilient prong, wherein the one or more first resilient prong include one or more protruding edge, a second portion having a second resilient prong, a third portion having a third resilient prong, a connecting portion between the first portion, the second portion and third portion, wherein the second portion extends substantially perpendicular to the connection portion and the third portion extends at an angle perpendicular to the connecting portion, wherein the first resilient prong/edge and the second resilient prong are configured to generate a biasing force to engage the planar object and the carrier together, wherein the first resilient prong/edge is insertable through a slot through the carrier to retain the planar object between the carrier and the second resilient prong, wherein the third resilient prong engages or enables the optic to snap-into and between two third resilient prongs and held in place above the second portions, of two dual member fastening elements.

### TECHNICAL FIELD

The present disclosure is directed generally to a dual member fastening element. More particularly, but not exclusively, embodiments disclosed herein relate to fastening a planar object, such as a LED board, and optics, such as lenes over the LED board, to a carrier, such as a luminaire housing.

Light-emitting diodes (LEDs) have the advantages of providing a bright light, being reasonably inexpensive, having a long operational life, and drawing very little power. Accordingly, LEDs are increasingly employed for a variety of illumination applications as an alternative to other forms of lighting, such as incandescent, halogen, etc.

As part of the luminaire manufacturing or assembly process, it is often necessary to fasten a LED board to a luminaire housing and an optics or lens assembly over the LED board. As there are several LED board and optics configurations and sizes across the lighting spectrum, the fastening process can be time-consuming and sometimes requires additional parts and/or other materials. Existing fastening methods include using screws, steel/aluminum rivets, and other specific plastic fasteners. With certain luminaire designs, these existing fastening methods may have to be employed with a combination of sheered lances and forms in the luminaire housing.

With the various fastening methods employed across product lines, it may require multiple fasteners employed in various forms and locations depending on the LED board and optics configurations and sizes. This causes inconsistency in manufacturing and assembly, which leads to added cost. Thus, there is a need for a versatile and inexpensive fastening apparatus to fasten the LED board and optics to the luminaire housing. Additionally, the fastening apparatus should be reliable and consistent regardless of the LED board and optics configurations and sizes.

The present disclosure is directed to an apparatus and a method for fastening an at least partially planar object, such as a LED board, and optics, such as lenes over the LED board, to a carrier, such as a luminaire housing. More particularly, in various embodiments, a dual member fastening element configured with selected aspects of the present disclosure may be employed to fasten at least partially planar objects of various sizes, e.g. LED board, and optics configurations to carriers. The dual member fastening element may clamp or snap-in over the edge of an at least partially planar object with a “spring” or snap-in edge pressure that firmly holds the planar object in place.

In some embodiments, the dual member fastening element may be constructed from insulator materials such as various types of plastic, therefore reducing or eliminating the potential for grounding or sparking issues if the dual member fastening element physically contacts an electrical trace. In some embodiments, the dual member fastening element may be employed in any luminaire fabricated from sheet metal, with the LED board as the light source.

In some embodiments, a dual member fastening element for engaging a planar object and optics to a carrier may include a first portion having one or more first resilient prongs that may each also include one or more protruding edge(s) to engage or snap-into a carrier; a second portion having a second resilient prong, a third portion having at least one third resilient prong that extends at an angle perpendicular to the connecting portion, a connecting portion between the first portion, the second portion, and the third portion, and a projection tab extending vertically from the connecting portion. The third resilient prong engages or enables an optic to snap-into and between two third resilient prongs and held or resting on the second portions of two dual member fastening elements. The first resilient prong/protruding edge and the second resilient prong may be configured to generate a first biasing force and a second biasing force respectively to engage the planar object and the carrier together. The second resilient prong may press against an exposed surface of the planar object, and the dual member fastening element may be insertable through a slot through the carrier to retain (and held by the first resilient prong's protruding edges) the carrier between the first and the second resilient prongs.

In some embodiments, a light emitting arrangement may include a light emitting diode (LED) board including at least one LED chip, a luminaire housing for receiving the LED board, one or more slots through the luminaire housing, and one or more dual member fastening elements gripping at least one dual member of the LED board and inserted through the one or more slots to engage the LED board and optics to the luminaire housing. Each of the one or more dual member fastening elements may include a second portion having one or more second resilient prong extending towards an exposed surface of the LED board, a first portion having a first resilient prong extending towards a surface of the luminaire housing, a third portion having a third resilient prong that extends at an angle perpendicular to the connecting portion, and a connecting portion between the first portion, the second portion and third portions, and a projection tab extending vertically from the connecting portion. The first resilient prong and the second resilient prong may be configured to exert opposing biasing forces on the LED board and the luminaire housing. The third resilient prongs of two dual member fastening elements may be configured to exert opposing biasing forces to enable an optic to be snaped into therebetween.

In some embodiments, a method of engaging one or more planar objects to a carrier using one or more dual member fastening elements may include placing the one or more planar objects above the carrier in a manner to align at least one dual member of the one or more planar objects with one or more slots through the carrier and inserting the one or more dual member fastening elements through the one or more slots to engage the one or more planar objects to the carrier via opposing biasing forces applied by the one or more dual member fastening elements onto the one or more planar objects and the carrier.

### BRIEF DESCRIPTION OF THE DRAWINGS

Features of the present disclosure are illustrated by way of example and not limited in the following figure(s), in which like numerals indicate like elements.

FIGS. 1A, 1B and 1C are perspective views of a dual member fastening element, according to an embodiment of the present disclosure.

FIG. 2 is a side view of the dual member fastening element of FIG. 1, attaching a planar object, such as a LED board, and optic, such as a lens, to a carrier, such as a luminaire housing, according to an embodiment of the present disclosure.

FIG. 3 is a perspective view of the dual member fastening element of FIG. 1 attaching a planar object, such as a LED board, and optic, such as a lens, to a carrier, such as a luminaire housing, according to an embodiment of the present disclosure.

FIG. 4 is a flow diagram of a processor for engaging a planar object and optic to a carrier with the dual member fastening element of FIG. 1, according to an embodiment of the present disclosure.

FIG. 5 is a side view of two three dual member fastening elements of FIG. 1, attaching a two planar objects, such as a LED boards, and optics, such as a lens, to a carrier, such as a luminaire housing, according to an embodiment of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. However, the present disclosure may be practiced without limitation to these specific details. In other instances, some methods and structures have not been described in detail so as not to unnecessarily obscure the present disclosure.

The elements depicted in the accompanying figures may include additional components and that some of the components described in those figures may be removed and/or modified without departing from scopes of the elements disclosed herein. The elements depicted in the figures may not be drawn to scale and thus, the elements may have different sizes and/or configurations other than as shown in the figures.

The examples discussed hereinafter will focus on the implementation of the hereinafter-described apparatus and techniques within LED applications. However, it will be appreciated that the apparatus and techniques may also be used in connection with other applications in different technology fields.

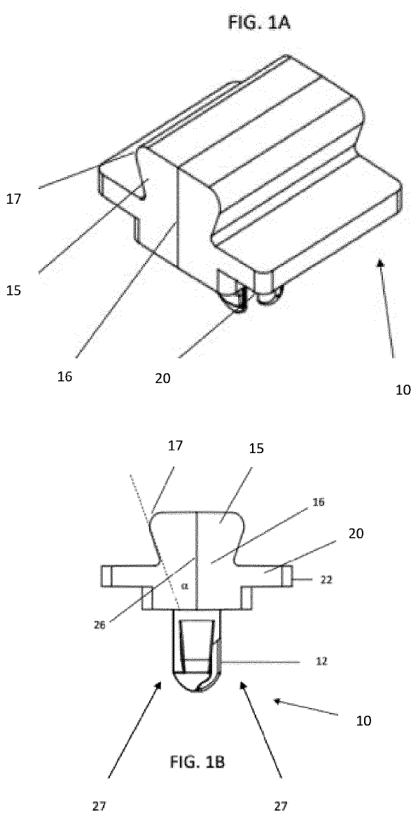

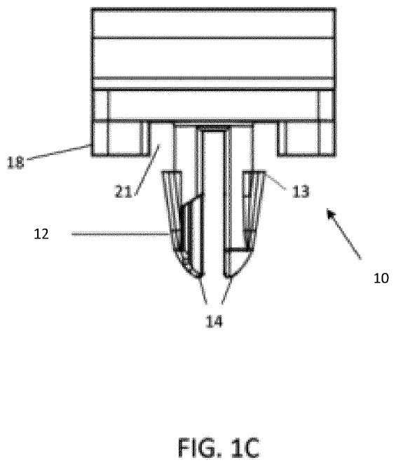

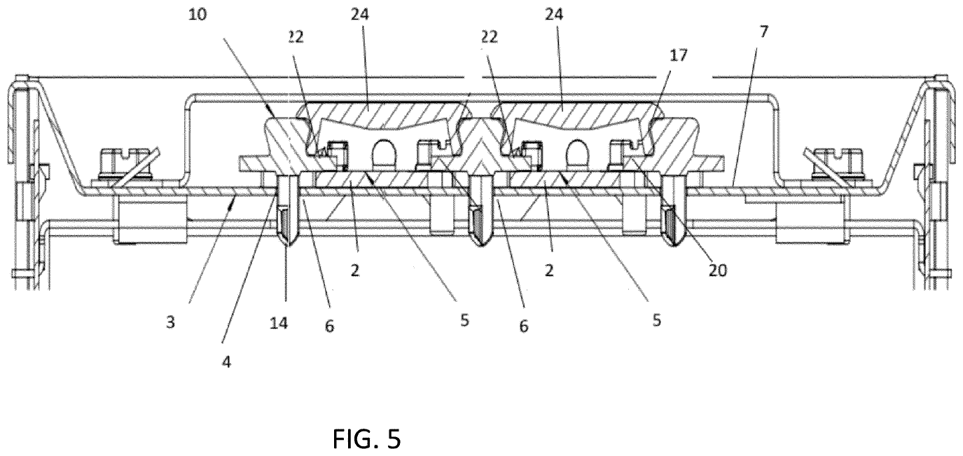

FIGS. 1A, 1B and 1C are perspective views of a dual member fastening element 10, in accordance with an embodiment of the present disclosure. The dual member fastening element 10 may include a first portion 12, a second portion 20, a third portion 15 and a connecting portion 16. The first portion 12 may include a first and second resilient prongs 14. In some embodiments, the one or more first resilient prongs 14 may also include one or more protruding edge(s) 13 to engage or snap-into a carrier 3 (see FIGS. 2 and 5), such as a luminaire housing. The second portion 20 comprises at least one resilient prong 22 that extends substantially perpendicular to the connection portion 16 to engage an at least partially planar object 2, e.g. LED board, as shown in FIGS. 1A and 1B. The third portion 15 comprises at least one third resilient prong 17 that extends at an angle (a) perpendicular to axis 26 and the connecting portion 16, as shown in FIGS. 1A and 1B. The third resilient prong 17 engages or enables an optic 24 to snap-into and between the third resilient prongs 17 of two dual member fastening elements 10 and held/supported in place above the second portions 20, as shown in FIGS. 2 and 5. Moreover, this provides a flush assembly between the optic 24 and the dual member fastening element 10. The connecting portion 16 may connect the first portion 12, the second portion 20 and the third portion 15. In some embodiments, at least one projection tab 18 may extend vertically (e.g., parallel) from connecting portion 16.

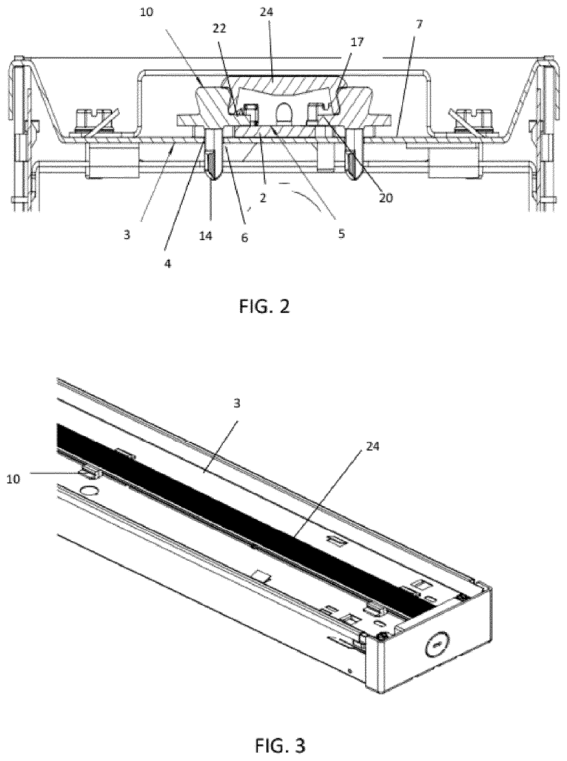

As shown in FIGS. 2 and 3, resilient prong 22 may extend towards an exposed surface 5 of an at least partially planar object 2, while the first and second resilient prongs 14 may extend towards a surface 6 of a carrier 3. The at least planar object 2 will be referred to herein simply as “planar object 2,” but it should be understood that there is no requirement that planar object be entirely, or even exactly, planar. For example, fastening elements 10 configured with selected aspects of the present disclosure may be used to secure an object that includes an at least generally, but not exactly, planar portion to another object, which may or may not also include a generally planar portion. In some embodiments, surfaces 5 and 6 may occupy parallel planes and may face opposite directions, as shown in FIGS. 2 and 5 where the exposed surface 5 faces upward and the surface 6 faces downward. In some embodiments, when dual member fastening element 10 is deployed, the connecting portion 16 between the first portion 12 and the second portion 20 may be perpendicular to another surface 7 of the carrier 3 and/or to the exposed surface 5 of planar object 2.

An optic 24 engages or snaps in between two dual member fastening elements 10. In particular, the optic 24 is pushed or snaped in between the respective offset portions 17 to at least partially rest between the respective offset portions 17 and the respective second portions 20 of the two dual member fastening elements 10. A portion of the optic 24 may extend beyond the dual member fasting element 10.

The projection tab 18 may extend vertically, and in some cases parallel with axis 26 and from the connecting portion 16, and in some embodiments may be approximately parallel to the surface 7 of the carrier 3 when fastening element 10 is deployed. In some embodiments, an offset portion 17. In some embodiments, the projection tab 18 may extend from the outer section of the connecting portion 16 to provide a gap 21 between the projection tab 18 and the second portion 12, as well as provide a spacer between the first portion 12 and the partially planar object 2, although this is not required.

In the embodiment as shown in FIG. 1, the dual member fasting element 10 has a symmetrical configuration around axis 26 and the first portions 12, the second portions 20 and third portions 17 are the same or mirror images. Accordingly, each dual member fasting element 10 has two sides 27 that are mirror images. In other embodiments, the first portion 12, the second portion 20 and the third portion 17 may be in different configurations. For example, second resilient prong 22 may different lengths. The offset portion 17 may extends at different angles perpendicular to the connecting portion 16. The first and second resilient prongs 14 may be different lengths to accommodate an uneven carrier 3.

The dual member fastening element 10 may be constructed from a relatively flexible material that allows the first and second resilient prongs 14 and the third portion's 15 at least one third resilient prong 17 to respectively exert opposing biasing forces upon the carrier 3 and the optic 24. In some embodiments, the dual member fastening element 10 may be made of an insulator material which is relatively flexible, such as different types of plastic, including, but not limited to, acrylic, polycarbonate, nylon, or any other plastic type materials that would be suitably strong enough to accomplish the desired outcome and meet certain standards and/or regulations (e.g., UL/ETL requirements). Being constructed with an insulator material, the dual member fastening element 10 may not interfere with (e.g., short) electrical traces, which adds to its versatility.

In some embodiments, the planar object 2 may be a LED board 2, and the carrier 3 may be a luminaire housing 3. In some such embodiments, the LED board 2 and the luminaire housing 3 (or components thereof) may be made of any suitable materials to allow the LED board 2 and the luminaire housing 3 to meet certain standards and/or regulations while also maintaining durability in light of the one or more conditions under which the LED board 2 may be exposed. Examples of such materials may include, but not limited to, aluminum, stainless steel, fiberglass, plastic, nylon, and rubber. As shown in FIG. 2, the LED board 2 may comprise one or more LED chips 1 on the exposed surface 5. The LED board 2 may be mounted on the surface 7 of the carrier 3 and then secured to carrier 3 by two or more dual member fastening elements 10. Optic 24 is snaped between two or more dual member fastening elements 10 and on top of the LED board 2. As shown in FIG. 2, two LED boards 2 may comprise one or more LED chips 1 on the exposed surface 5. The LED boards 2 may be mounted on the surface 7 of the carrier 3 and then secured to carrier 3 by three dual member fastening elements 10. Optic 24 is snaped between three dual member fastening elements 10 and on top of the LED board 2.

The number of LED chips 1, LED boards 2 and optics 24 may vary, and the LED chip 1, the LED board 2 and optic 24 may be arranged in different arrays or configurations. The LED chip 1 described herein may include any type of LED technology, including, but not limited to, chip on board or discrete dies. Besides the normal LED chip 1, in some embodiments, the LED board 2 may have other different types of light sources, such as light-organic LEDs (OLEDs) chips, disposed thereon. The LED chip 1 may be electrically coupled to each other. For example, multiple LED chips 1 may be electrically series-connected in some way, for example, in a row. Control and/or power signals (e.g., voltage, current) may be delivered to the LED board 2 by a power source (e.g., a LED driver) located within, on, and/or external to the LED board 2 (not shown here). Such power and/or control signals may be used to illuminate the LED chip 1 on the LED board 2.

As mentioned above, one or more dual member fastening elements 10 may be used to secure the planar object 2 to the carrier 3 and an optic 24 to the dual member fastening elements 10. For example, as shown in FIGS. 2 and 3, dual member fastening elements 10 may be deployed in pairs on both sides of the planar object 2 and inserted through respective slots 4. The slots 4 may be provided through the carrier 3 according to specific size of the planar object 2. In some embodiments, the symmetric arrangement of the slots 4 with corresponding dual member fastening elements 10 located along a length of both sides of the planar object 2 may be replaced by other configurations, such as a random placement of the slots 4 and corresponding dual member fastening elements 10 along a length of one or both sides of the planar object 2. In the LED application, different numbers and/or configurations of slots 4 may be employed in order to accommodate various LED board widths for different performance requirements.

The shape and/or size of the slot 4 may vary. In some embodiments, the slot 4 may be punched into the carrier 3 as a rectangular shape. In some such embodiments, the fastening element 10 may have a cross sectional shape or profile (looking along the first portions 12) that is similarly circular. However, the slot 4 may be any size and/or shape, and fastening element 10 in general.

In use, multiple dual member fastening elements 10 may generate opposing biasing forces to respectively engage multiple planar objects 2 and the carrier 3 together, as well as generate opposing biasing forces to engage the optic 24 there between. As shown in FIGS. 2 and 5. with the planar object 2 in place, the second resilient prong 22 is exposed surface 5 from a default position to a tensioned position when the dual member fastening element 10 is inserted into slot 4. In addition, the first and second resilient prongs 14 grip the carrier 3 by a biasing force and the one or more protruding edge(s) 13, when inserted into slot 4, engage or snap-into surface 6 of carrier 3.

Similarly, while inserting or snapping the optic 24 between the two dual member fastening elements 10, opposing biasing forces are generated to engage and hold the optic 24 there between. In addition, the third resilient prong 17 further engages the optic 24 to prevent it from removed without additional vertical force be applied.

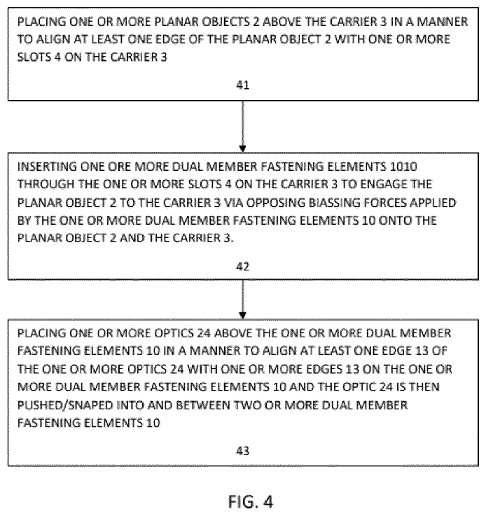

FIG. 4 is a flow diagram illustrating an example method 40 for using the dual member fastening element 10 to fasten the planar object 2 and optic 24 to the carrier 3. Referring generally to FIGS. 1-4, method 40 may begin at block 41, one or more planar objects 2 may be placed above the carrier 3 in a manner to align at least one dual member of the planar object 2 with one or more slots 4 on the carrier 3. In block 42, one or more dual member fastening elements 10 may be snaped into or inserted through the one or more slots 4 on the carrier 3 to engage the planar object 2 to the carrier 3 via opposing biasing forces onto the planar object 2 and the carrier 3 via the first portion 12 and second portions 20. In block 43, one or more optics 24 may be placed above the one or more dual member fastening elements 10 in a manner to align at least one edge of the one or more optics 24 with one or more protruding edges 13 on the one or more dual member fastening elements 10 and the optic 24 is then pushed/snaped into and between two or more dual member fastening elements 10.

Using the dual member fastening element 10 described herein allows for flexibility in mounting LED board and optics configurations. The dual member fastening element 10 may accommodate any (at least partially) planar objects 2 with any widths and/or any thickness, e.g., up to 2 mm. The dual member fastening element 10 can be removed easily for repair and/or replacement. The installation process of the dual member fastening element 10 is also faster and less expensive than using the equivalent number of other fasteners, such as screws, as the dual member fastening element 10 snaps into place without the need of other tools, such as rotary drivers, for installation. The dual member fastening element 10 requires no sheer formed lances to be used in combination, therefore the planar object 2 is not limited to be mounted in a specific location on the carrier 3. Consequently, the surface 7 of the carrier 3 remains clear and flat.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

1. A light emitting arrangement, comrpising:
a light emitting diode (LED) board;
an optic config ed above the light emitting diode (LED) board;
a luminaire housing for receiving the LED board; and
two dual member fastening elements oppositely placed and engaging the LED board therebetween;
wherein the eahc dual member fastening element includes,
a first portion having a first resilient prong;
second portions having second resilient prongs;
third portions having third resilient prongs;
wherein respective first resilient prongs and respective second resilient prongs are configured to generate a biasing force to fasten the light emitting diode (LED) board to the luminaire housing;
wherein respective third resilient prongs engages or enables the optics to snap-into and between the respective third resilient prongs.

2. The light emitting arrangement of claim 1, wherein the third resilient prong is at an acute angle with respect to the first portion.

3. (canceled)

4. (canceled)

5. The light emitting arrangement of claim 1, wherein the dual member fastening element is constructed with an electrically non-conductive material.

6. The light emitting arrangement of claim 5, wherein the electrically non-conductive material is at least one of acrylic, polycarbonate, or nylon.

7. (canceled)

8. The light emitting arrangement of claim 1, wherein the first resilient prong includes one or more protruding edge that snap into a slot of the carrier.

9. (canceled)

10. A light emitting arrangement, comprising:
a light emitting diode (LED) board;
an optic configured above the light emitting diode (LED) board;
a luminaire housing for receiving the LED board; and
two dual member fastening elements oppositely placed and engaging the LED board therebetween;
wherein the each dual member fastening element includes,
a first portion having a first resilient prong;
symmetrical second portions having second resilient prongs;
symmetrical third portions having third resilient prongs;
wherein respective first resilient prongs and respective second resilient prongs are configured to generate a biasing force to fasten the light emitting diode (LED) board to the luminaire housing;
wherein respective third resilient prongs engages or enables the optics to snap-into and between the respective third resilient prongs.

11. The light emitting arrangement of claim 6, further including:
a second light emitting diode (LED) board;
a third dual member fastening elements; and
wherein each dual member fastening element is oppositely placed between one or both of the LED boards; and
wherein each light emitting diode (LED) board is fastened to housing with the biasing force of two respective first resilient prongs and respective second resilient prongs, and each optic is snapped into and between two third resilient prongs.
